(19) United States
(12) Patent Application Publication
(10) Pub. No.: US 2015/0125113 A1
(43) Pub. Date: May 7, 2015

(54) FIBER OPTIC SOLAR COLLECTOR

(71) Applicants: Jerome Schreiber, Huntington Beach, CA (US); Abi Motamedi, Los Angeles, CA (US)

(72) Inventors: Jerome Schreiber, Huntington Beach, CA (US); Abi Motamedi, Los Angeles, CA (US)

(21) Appl. No.: 14/070,521

(22) Filed: Nov. 2, 2013

(51) Int. Cl. G02B 6/32; G02B 6/26

(52) U.S. Cl. CPC G02B 6/32; G02B 6/262
USPC 385/35

(57) ABSTRACT

A solar collector which concentrates sunlight by a matrix of solar luminescence concentrators that are made up of fiber optic material which collect and concentrate light assembly into fiber optic cables and which guide the light to a desired location where it can be used for lighting or photo voltaic conversion into electricity.

### FIELD OF THE INVENTION

The present invention relates to an improvement in a solar collector which concentrates sunlight through a matrix of many small luminance optical concentrators that are made up of fiber optic material which collect and concentrate light and conveys it into an assembly of fiber optic cables.

### DESCRIPTION OF PRIOR ART

Utilization of renewable solar energy is a key to energy saving and attracting increasing attention in various fields today.

The following prior art discloses the various aspects in the design and use of luminance solar collectors.

With a variety of alternative electrical generation systems available, none is becoming more prevalent than those which convert solar energy to electricity. These systems are known as photovoltaic systems.

A photovoltaic system consists of photovoltaic solar panels and other electrical components used to capture solar energy and convert it to electrical power.

Currently photovoltaic panels are commonly installed on rooftops. This presents a significant safety problem for fire departments because there is no easy way to shut off the electricity on the roof when a day time fire occurs, as the photovoltaic solar panels and other electrical components used to capture solar energy and convert it to electrical power are not able to be turned off.

Another problem that arises with photo voltaic panels installed on the roof of a house is the shading effect of tree and other shadows that do not permit it to realize its full potential due to the partial or temporary shading. Whether caused by a neighbor's trees or their own chimneys, homeowners may be losing between 20-40% of the potential output of their solar installations because of shade. A 10% shading of a solar array can lead to a 50% decline in efficiency, and sometimes even a total system shutdown.

The shading that causes this loss of efficiency can come in many forms. Depending on the object causing the shading, it may only be seasonal, or for a few hours each day, resulting in apparently mysterious fluctuations in the power.

The loss of energy caused by partial shading of solar modules is difficult to predict because it depends on several variables including, but not limited to internal module-cell interconnections, module orientation, how modules are connected within an array, and the configuration of the inverter.

### Advantages of Current Invention

The luminance solar collector would eliminate shading by evenly distributing the light over the photovoltaic cells. Photovoltaic cells operate more efficiently in a cooler environment and instead of being installed outside exposed to heat can be installed in a location that provides a temperature controlled environment. The luminance solar collector can collect visible light and not infrared light which causes the photovoltaic cells to run cooler and produce more electricity.

### SUMMARY OF THE INVENTION

For the most effective use of solar energy, it should be availed as optical energy, that is, without being transformed into any other kind of energy, such as electricity or heat.

In light of this, it is the primary object of the present invention to provide a system which collects the solar energy or light and to guide it through fiber optic cables to a location where lighting is needed or where photo voltaic can convert it to electricity.

It is therefore an object of the present invention to provide an improvement in a solar collector which concentrates sunlight through a matrix of many small luminance optical concentrators that are made up of fiber optic material which collect and concentrate light assembly into fiber optic cables. The fiber optic cables guide the light to a desired location. Where they can be used for lighting or photo voltaic conversion into electricity.

More particularly, the present invention is concerned with an improvement in collection of sun light. There is a variety of ways to collect sun light, some from mirrors, some from Fresnel lenses. What makes this invention most useful is that by having a low profile and light weight, it can be mounted more easily on roof tops than prior art solar collectors.

By having numerous small cones of luminance optical concentrators the applicant's proposed lighting system, a luminance optical concentrator has the core shaped into a convex lens to enhance light entering at an angle that will have the total reflection of the light.

The geometrically decreasing area of the fiber optic material is shaped into a converging angle that bends the light into the optical material that guides light according to Snell's Law. While the shape that decreases within the acceptance angle could take the form of any shape, such as a tear drop, the preferred shape is a cone shape, as it is the easiest to fabricate. The cones act as light funnels that concentrate the light. Even though the acceptance angle of the cone may be very acute, the combination of a convex lens and a shrinking radius of the cone will concentrate light-gathering with very small physical profile if there are many luminance optical concentrators are used.

The converged sunlight is conducted by a fiber optic cable to a desired station. The luminance optical concentrators may be glued or have a frame for holding the luminance optical concentrators in a matted or tarp like canvas material that is malleable but is sunlight and heat resistant.

The conduction of solar energy through a fiber optic cable as described above provides for visible lighting which is free from conversion loss or the-like, realizing the most efficient use of solar energy. Note, because it does not convey infrared light, only visible light, one can have light without large amounts of heat. This saves on air conditioning bills and is especially useful for illumination in refrigerated spaces.

The primary requisite in each of the solar luminance optical concentrator of the type described is that the light receiving end of each fiber optic cable be held in a matted or tarp like canvas that is malleable, but sunlight and heat resistant, each having a convex lens with the focal point far into the center of the core associated therewith; otherwise, the sunlight converged by the lens would fail to be efficiently introduced into the cable. It must be directed to the sun so that the solar light is within the convex lens' acceptance angle of the light funnel.

Because the location of the Sun is dynamic and changes, location from sunrise to sunset and changes position based on the Seasons A convex lens made out of the core material allows for the acceptance of light at much greater angles than the 10 degree angles the light is limited to without the convex lens.

An addition to the convex lens would be an incorporation of a gradient index to the core material. This gradient index fiber is an optical material whose core has a refractive index that decreases with increasing radial distance from the optical axis of the fiber.

Since the parts of the core closer to the fiber axis have a higher refractive index than the parts of the cladding, light rays follow sinusoidal paths down the fiber which is nearly parabolic. This parabolic profile results in continual refocusing of the rays in the core, minimizing the requirement to be pointed directly at the sun.

The design of a single Solar luminance optical concentrator/collector is basically in the shape of cone with a sphere of core material capping it which refocuses and concentrates light out of the fiber optic cable.

Utilizing Snell's equation to determine the optimum dimensions of the cone is similar to a funnel concentrating water.

By way of example, if the cone possessed a diameter of 1 mm, the maximum angle is determined by the index of the refraction ratio. Utilizing the standard index of refraction of common fiber-optic cable cladding material index of refraction of 1.52 and dividing that by the index of refraction of common fiber-optic core material of 1.62 would generate a result of 0.938. Taking the Arc Sine of 0.938 would give us 69.7 degrees. This result is the angle referenced to perpendicular to the point where the light contacts the surface between the core and the cladding. The complimentary angle of this is 20.3 degrees, half of which is approximately a 10 degree angle. Taking the cos 10°/sine 10° determines the ration of the height to width of the right angle that revolves around the center of the of the core that revolves around that makes up the cone.

By utilizing geometric equations with a maximum angle determined by Snell's Equation, we find that the optimal height of the cone is approximately six time the size of the radius of the cone. In our example our radius of 0.5 mm would have a height of 3 mm.

In order to incorporate the invention into a matted surface it must be able to bend ninety degrees from the cone's base. Industrial standard radius bend without degradation to the fiber-optic is 15 times the radius of the fiber-optic cable.

The standard cable radius is 0.0625 mm the bend would be 0.9375 or approximately 1 mm. By adding the 1 mm bending radius to the height of the cone we obtain a 4 mm thickness in the matted surface.

To give the matrix of cones additional structural and flexible integrity, fiberglass reinforcement may be utilized.

The most uniform way of compressing cones together to cover a surface would be to use cones in a hexagonal shape. If it is desired to capture all the light coming to the matrix of solar collecting cones, one could compress the edges of the circular cone into a hexagonal shape so that all the light hitting the matted surface would be absorbed. Taking the ratio of the area of a circle and the area of a hexagon we see that the area diminishes 17 percent, however, the ability to utilize more hexagonal cones in the area would be able to make up this difference.

### BRIEF DESCRIPTION OF THE DRAWINGS

A complete understanding of the invention may be obtained by reference to the accompanying drawings when taken in conjunction with the detailed description thereof and in which:

FIG. 1 is a cross-section of the invention, displaying the core (1), cladding (2), equipped with a converging convex lens (8).

FIG. 2 is an cross-section of the invention equipped with a convex lens displaying the collection of light from the sun.

FIGS. 3 and 4 are examples of a matrix of the solar luminescent concentrators, displaying the convex lenses and fiber optic cables.

FIG. 5 displays the invention with a long fiber-optic cable attached to the cone concentrator.

A better understanding and appreciation of these and other objects and advantages of the present invention will be obtained upon reading the following detailed description of the preferred embodiment when taken in conjunction with the accompanying drawings.

### DETAILED DESCRIPTION OF THE INVENTION

The present invention relates to an improvement in a solar collector which concentrates sunlight by matrix of a plurality of small solar luminance optical concentrators that are made up of fiber optic material which collect and concentrate light assembly into fiber optic cables. The present invention includes the components or elements shown as follows:

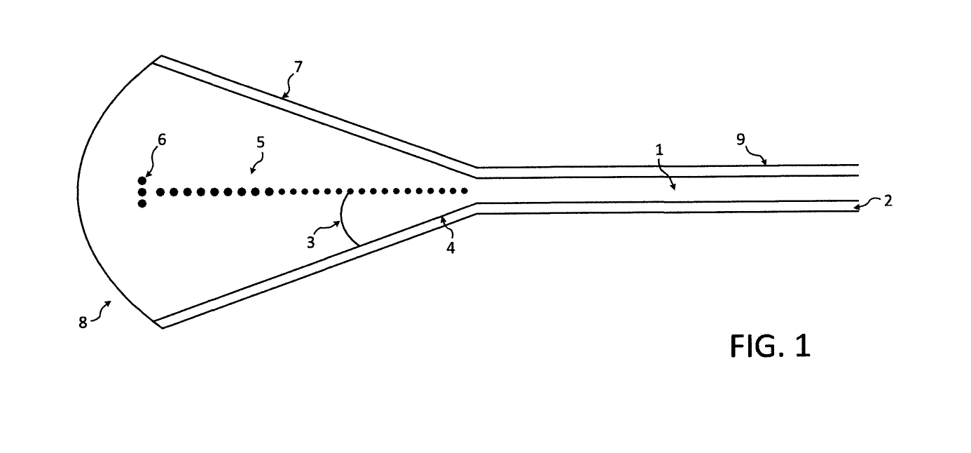

Shown in FIG. 1 is a cross section of the interior of the invention which closely resembles a typical optical fiber. The invention is composed of core (1) and cladding (2). The preferred dimensions of the invention would be to find an optimum concentration of light through its acceptance angle. To discover the acceptance angle (3) would be to calculate the index of refraction of the cladding (4) divided by the core index of refraction (5) obtaining the Arc Sin of that dividend and subtract that result (6) from 90 degrees to obtain the complimentary angle. That result will be the optimum acceptance angle (3). Taking half the value of the acceptance angle (3) will result in the optimum value of the angle of the cone shape of the solar luminance optical concentrator (7).

The amount of light passing within the solar collector (7) can be increased by utilizing a convex lens (8) which bends light towards a focal point farther down the center of the core of the cone.

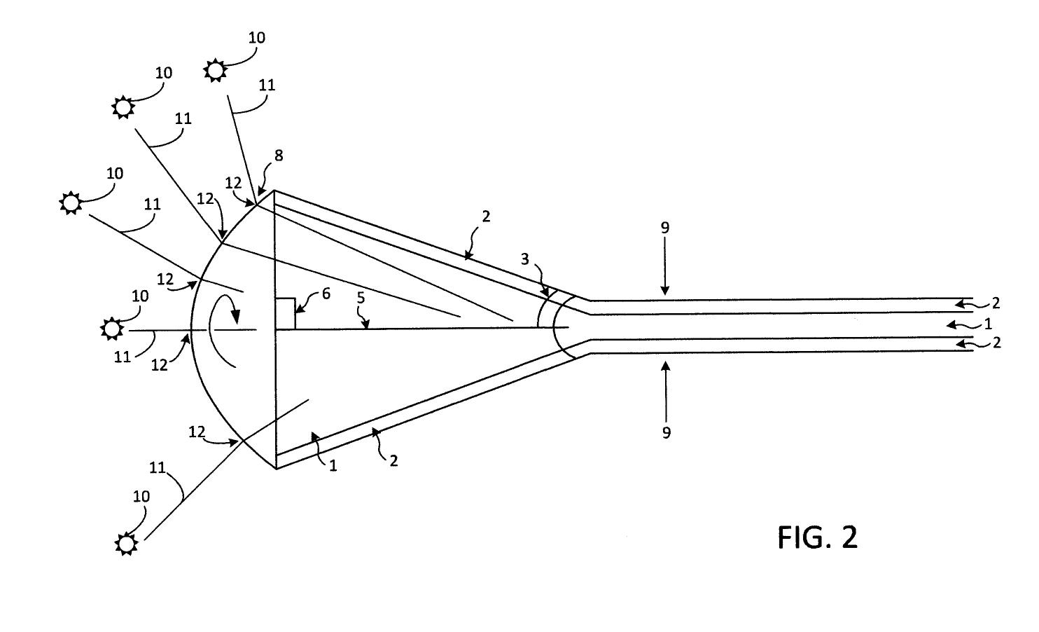

FIG. 2 is an cross-section of the invention equipped with a convex lens (8) displaying the collection of light from the sun (9) at different times of the day and/or season. As shown the rays of light from the sun (10) are bent (11) when passed through the convex lens (8) through the core (1).

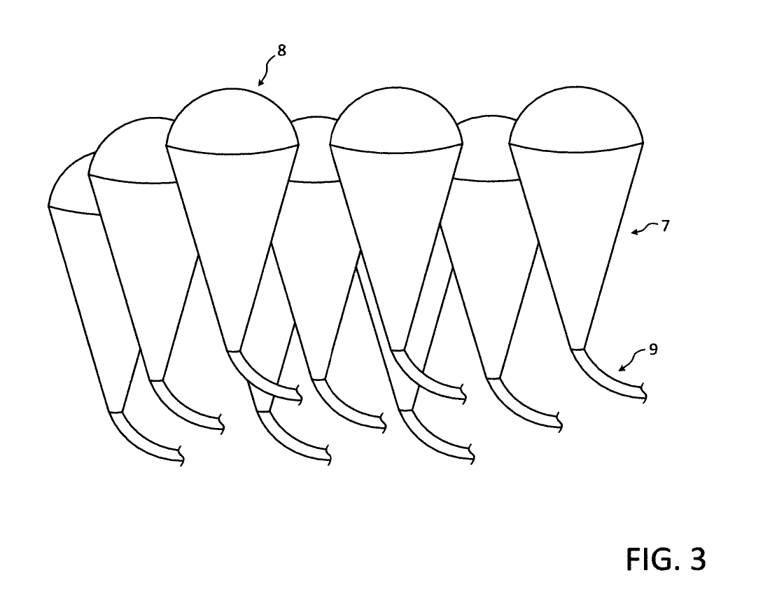

FIG. 3 displays a side view of a matrix of the solar luminescent collector (7). As illustrated, the convex lens (8) are placed side by side along the funnel shape of the solar concentrator (7) with the fiber optic cable (9) at the narrow end to the solar concentrator (7).

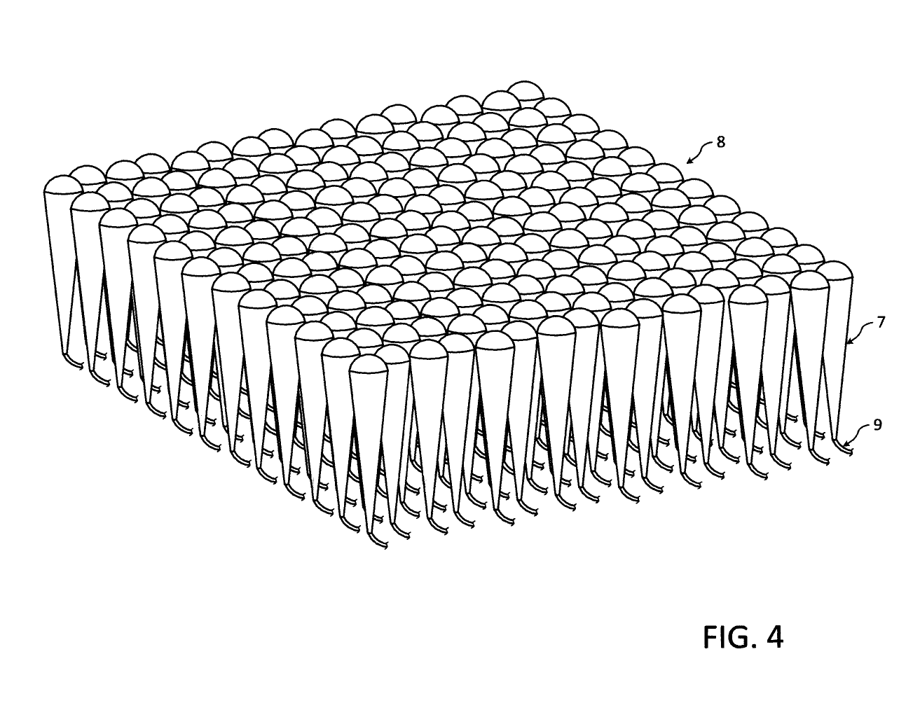

FIG. 4 displays a perspective view of a matrix of the solar luminescent collectors (7). As similarly illustrated in FIG. 3, FIG. 4 displays a side view of a matrix of the solar luminescent collector. As illustrated, the convex lens (8) are placed side by side along the funnel shape of the solar concentrator (7) with the fiber optic cable (9) at the narrow end to the solar concentrator (7).

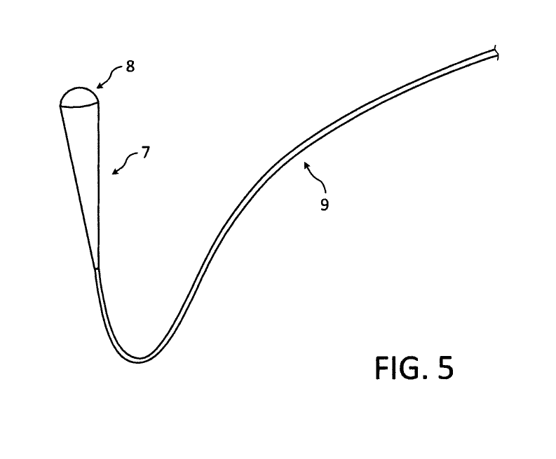

FIG. 5 displays a perspective view of a single solar luminance optical concentrator (7) with convex lens (3) and resulting fiber optic cable (9).

What is claimed is:

1. A solar fiber optic solar collector for concentration of sunlight, comprising:
a plurality of individual solar luminescent optical concentrators:
said collector possessing a core,
said core encased in cladding,
said core capped with a spherical convex lens made of core optical material.

2. The solar luminescent optical concentrator as defined in claim 1,
said solar luminescent optical concentrator being capped with a spherical convex lens made of core optical material such that solar light is converged to the center of the core,
said solar luminescent optical concentrator being uniquely funnel shaped,
said solar luminescent optical concentrator possessing a large round open end on one side and a smaller open end on the opposite site,
said solar luminescent optical concentrator to accept light at the larger open end,
said solar collector to possess a fiber optic cable at the opposite end of the larger open end,
said solar collector to propagate light through the fiber optic cable.

3. The solar luminescent optical concentrator as defined in claim 2, wherein a convex lens is fitted upon the large open end of the collector to bend light towards a focal point deep within the core nearest the attachment of the fiber optic cable.

4. The solar luminescent optical concentrator as defined in claim 2, wherein the large open end is hexagonal shaped.

5. The solar luminescent optical concentrator as defined in claim 2, wherein said solar luminescent optical concentrator being uniquely funnel shaped such funnel shape is defined by the preferred angle which is ½ {90−[Arc Sin]} rotated about the center of the Core.
